(19) United States
(12) Patent Application Publication
(10) Pub. No.: US 2025/0182425 A1
(43) Pub. Date: Jun. 5, 2025

(54) HUMAN-COMPUTER INTERACTION METHOD AND APPARATUS, DEVICE, AND MEDIUM

(71) Applicant: Beijing Zitiao Network Technology Co., Ltd., Beijing (CN)

(72) Inventors: Rongxuan MU, Beijing (CN); Shuo LIU, Beijing (CN); Chi FANG, Beijing (CN); Mengqian LIU, Beijing (CN); Chin-Wei LIU, Beijing (CN); Jia GUO, Beijing (CN)

(21) Appl. No.: 18/966,812

(22) Filed: Dec. 3, 2024

(30) Foreign Application Priority Data
Dec. 4, 2023 (CN) 202311649919.9

(51) Int. Cl. G06T 19/20; G06F 3/01

(52) U.S. Cl. CPC G06T 19/20; G06F 3/013; G06F 3/017; G06T 2219/2004; G06T 2219/2016

(57) ABSTRACT

The present application provides a human-computer interaction method and apparatus, a device, and a medium. The method includes: determining a gaze point of a line of sight of a user on a target object, the target object being located in a virtual space; adjusting, in response to an interaction gesture for the gaze point, a display form of the gaze point to generate a first interaction point; and interacting with the target object based on the first interaction point.

### CROSS-REFERENCE TO RELATED APPLICATIONS

The present application is based on and claims priority to Chinese Patent Application No. 202311649919.9 filed on Dec. 4, 2023, the disclosure of which is incorporated by reference herein in its entirety.

### TECHNICAL FIELD

Embodiments of the present application relate to the technical field of human-computer interaction, and in particular, to a human-computer interaction method and apparatus, a device, and a medium.

### BACKGROUND

With the continuous development of an extended reality (XR) technology, more and more users use XR devices to enter different virtual scenes and interact with various objects in the virtual scenes.

### SUMMARY

Embodiments of the present application provide a human-computer interaction method and apparatus, a device, and a medium.

According to a first aspect, an embodiment of the present application provides a human-computer interaction method. The method includes:
determining a gaze point of a line of sight of a user on a target object, where the target object is located in a virtual space;
adjusting, in response to an interaction gesture for the gaze point, a display form of the gaze point to generate a first interaction point; and
interacting with the target object based on the first interaction point.

According to a second aspect, an embodiment of the present application provides a human-computer interaction apparatus. The apparatus includes:
a determination module configured to determine a gaze point of a line of sight of a user on a target object, where the target object is located in a virtual space;
an adjustment module configured to adjust, in response to an interaction gesture for the gaze point, a display form of the gaze point to generate a first interaction point; and
an interaction module configured to interact with the target object based on the first interaction point.

According to a third aspect, an embodiment of the present application provides an electronic device. The electronic device includes:
a processor and a memory, where the memory is configured to store a computer program, and the processor is configured to call and run the computer program stored in the memory to perform the human-computer interaction method as described in the embodiment in the first aspect or various implementations thereof.

According to a fourth aspect, an embodiment of the present application provides a computer-readable storage medium, which is configured to store a computer program. The computer program causes a computer to perform the human-computer interaction method as described in the embodiment in the first aspect or various implementations thereof.

According to a fifth aspect, an embodiment of the present application provides a computer program product including program instructions. The program instructions, when run on an electronic device, cause the electronic device to perform the human-computer interaction method as described in the embodiment in the first aspect or various implementations thereof.

### BRIEF DESCRIPTION OF THE DRAWINGS

To describe the technical solutions in the embodiments of the present application more clearly, the following briefly describes the accompanying drawings required for describing the embodiments. Apparently, the accompanying drawings in the following description show merely some embodiments of the present application, and a person of ordinary skill in the art may derive other drawings from these accompanying drawings without creative efforts.

FIG. 1 is a flowchart of a human-computer interaction method according to an embodiment of the present application;

FIG. 2 is a schematic diagram showing that a gaze point is displayed on a panel when a user gazes at the panel according to an embodiment of the present application;

FIG. 3a is a schematic diagram of a first gesture according to an embodiment of the present application;

FIG. 3b is a schematic diagram of another first gesture according to an embodiment of the present application;

FIG. 3c is a schematic diagram of generating a first interaction point based on a gaze point according to an embodiment of the present application;

FIG. 4a is a schematic diagram of controlling, based on a first gesture, a first interaction point to move a target object according to an embodiment of the present application;

FIG. 4b is top view of another example of controlling, based on a first gesture, a first interaction point to move a target object according to an embodiment of the present application;

FIG. 5a is a schematic diagram of a second gesture according to an embodiment of the present application;

FIG. 5b is a schematic diagram of another second gesture according to an embodiment of the present application;

FIG. 6a is a schematic diagram of a third gesture according to an embodiment of the present application;

FIG. 6b is a schematic diagram of zooming in a target object according to an embodiment of the present application;

FIG. 7 is a flowchart of another human-computer interaction method according to an embodiment of the present application;

FIG. 8 is a schematic diagram of an observable region corresponding to a first interaction point according to an embodiment of the present application;

FIG. 9 is a schematic diagram of optimizing a display position of a second interaction point according to an embodiment of the present application;

FIG. 10 is a schematic diagram of moving a target object based on a center point of a line segment between a first interaction point and a second interaction point according to an embodiment of the present application;

FIG. 11a is a schematic diagram of zooming in a target object based on a center point of a line segment between a first interaction point and a second interaction point according to an embodiment of the present application;

FIG. 11b is a schematic diagram of rotating a target object based on a center point of a line segment between a first interaction point and a second interaction point according to an embodiment of the present application;

FIG. 12 is a schematic diagram of first zooming out and then zooming in a target object according to an embodiment of the present application;

FIG. 13 is a schematic block diagram of a human-computer interaction apparatus according to an embodiment of the present application; and

FIG. 14 is a schematic block diagram of an electronic device according to an embodiment of the present application.

### DETAILED DESCRIPTION

The technical solutions in the embodiments of the present application will be described clearly and completely below with reference to the accompanying drawings in the embodiments of the present application. Apparently, the described embodiments are only some rather than all of the embodiments of the present application. All other embodiments obtained by a person of ordinary skill in the art based on the embodiments of the present application without creative efforts shall fall within the protection scope of the present application.

It should be noted that the terms “first”, “second”, etc. in the description and claims of the present application as well as the above-mentioned accompanying drawings are used to distinguish similar objects, and are not necessarily used to describe a specific order or a precedence order. It should be understood that data termed in such a way may be interchanged where appropriate, so that the embodiments of the present application described herein can be implemented in a sequence other than those illustrated or described herein. In addition, the terms “include” and “have” and any variants thereof are intended to cover a non-exclusive inclusion. For example, a process, method, system, product, or device that includes a list of steps or units is not necessarily limited to those expressly listed steps or units, but may include other steps or units not expressly listed or inherent to such a process, method, product, or device.

In the embodiments of the present application, the term “exemplary”, “for example”, etc. is used to represent an example, an illustration, or a description. Any embodiment or solution described by “exemplary” or “for example” in the embodiments of the present application should not be construed as being preferred or advantageous over other embodiments or solutions. To be precise, the term “exemplary” or “for example” is intended to present a related concept in a specific manner.

In the description of the embodiments of the present application, unless otherwise stated, “a plurality of” means two or more, that is, at least two. “At least one” means one or more.

In order to facilitate understanding of the embodiments of the present application, before the embodiments of the present application are described, some concepts as referred to in all the embodiments of the present application are first appropriately explained as follows:
(1) Virtual reality (VR) is a technology that allows for the creation and experience of a virtual world. It determines and generates a virtual environment, and is multi-source information (virtual reality mentioned herein includes at least visual perception, may further include auditory perception, tactile perception, and motion perception, and even includes gustatory perception, olfactory perception, and the like). This technology achieves an integrated, interactive three-dimensional dynamic visual scene of the virtual environment and simulation of entity behavior, immersing a user in a simulated virtual reality environment, and realizing applications in a plurality of virtual environments such as maps, games, videos, education, medical care, simulation, collaborative training, sales, assisted manufacturing, maintenance, and repair.
(2) A VR device is a terminal that achieves virtual reality effects, and may generally be provided in the form of glasses, a head-mounted display (HMD), or contact lenses, to implement visual perception and other forms of perception. Certainly, the VR device is not limited to these implementation forms, and may be further miniaturized or enlarged according to actual needs.

Optionally, the VR device described in the embodiments of the present application may include, but is not limited to, the following types:
(2.1) A personal computer virtual reality (PCVR) device: It performs computation related to a virtual reality function and data output by using a PC, and an external personal computer virtual reality device achieves virtual reality effects by using data output by the PC.
(2.2) Mobile virtual reality device: It supports providing a mobile terminal (for example, a smartphone) in various manners (for example, a head-mounted display provided with a special slot), and is connected to the mobile terminal in a wired or wireless manner. The mobile terminal performs computation related to a virtual reality function, and outputs data to the mobile virtual reality device. For example, a virtual reality video is watched through an APP of the mobile terminal.
(2.3) Integrated virtual reality device: It has a processor configured to perform computation related to a virtual function, and therefore has an independent virtual reality input and output function, with no need to be connected to a PC or a mobile terminal, providing a high degree of freedom of use.
(3) Augmented reality (AR) is a technology for computing, in real time in a process in which a camera acquires the image, a camera posture parameter of the camera in the physical world (or referred to as a three-dimensional world or a real world) and adding, based on the camera posture parameter, a virtual element to the image acquired by the camera. The virtual element includes, but is not limited to, an image, a video, and a three-dimensional model. An objective of the AR technology is to overlay the virtual world to the physical world on a screen for interaction.
(4) Mixed reality (MR) means that virtual scene information is presented in a physical scene to build up an information loop for interactive feedback between the physical world, the virtual world, and a user, to enhance the sense of reality in user experience. For example, a sensory input (for example, a virtual object) created by a computer and a sensory input from a physical setting or a representation thereof are integrated into a simulated setting. In some MR settings, the sensory input created by the computer may adapt to changes in the sensory input from the physical setting. In addition, some electronic systems configured to present an MR setting may monitor an orientation and/or a position relative to the physical setting, so that the virtual object can interact with a real object (that is, a physical element from the physical setting or a representation thereof). For example, the system may monitor motion, so that a virtual plant looks still relative to a physical building.
(5) XR means combining reality and virtuality through a computer to create a virtual environment that allows human-computer interaction. XR is also an umbrella term for a plurality of technologies such as VR, AR, and MR. By integrating the three visual interaction technologies, XR makes a user “immersive” in seamless switching between a virtual world and a physical world.
(6) Virtual scene is a virtual scene that is displayed (or provided) when an application program runs on an electronic device. The virtual scene may be a simulated environment of a real world, or may be a semi-simulated semi-fictional virtual scene, or may be an entirely fictional virtual scene. The virtual scene may be any one of a two-dimensional virtual scene, a 2.5-dimensional virtual scene, or a three-dimensional virtual scene. A dimensionality of the virtual scene is not limited in this embodiment of the present application. For example, the virtual scene may include sky, land, and sea, and the land may include environmental elements such as a desert and a city. The user may control a virtual object to move in the virtual scene. It should be understood that the above virtual scene may also be referred to as a virtual space.
(7) A virtual object is an object that interacts in the virtual scene and is controlled by a user or a robot program (e.g., an artificial intelligence-based robot program), and can remain stationary, move, and perform various behaviors in the virtual scene, such as various characters in a game.

Generally, when interacting with an object in a virtual scene, a user needs to use an interaction apparatus such as a gamepad, for example, use light cast by the gamepad to select a target object, and press a specific key to trigger an action such as confirmation and switching. However, this interaction mode using the interaction apparatus is relatively cumbersome and not flexible, affecting interaction experience.

In order to solve the above technical problems, the inventive concept of the present application is as follows: For a scenario in which a user interacts with an object in a virtual space, a line of sight of the user is tracked to determine a gaze point of the line of sight of the user. When the gaze point of the line of sight of the user is on a specific target object in the virtual space, based on an interaction gesture triggered by the user, a display form of the gaze point is adjusted to generate a first interaction point, and then the first interaction point is controlled to perform an operation of interacting with the target object, so as to achieve convenient interaction with the target object without relying on any interaction apparatus, which improves flexibility of the interaction with the target object, makes human-computer interaction more natural, and also enhances diversity and interestingness of human-computer interaction, thereby improving atmosphere and interaction experience of human-computer interaction.

The technical solutions of the present application are described in detail below through some embodiments. Embodiments described below may be combined with each other, and the same or similar concepts or processes may not be described again in some embodiments.

Embodiments of the present application provide a human-computer interaction method and apparatus, a device, and a medium, so that interaction with a target object can be performed without relying on an interaction apparatus, which improves flexibility of the interaction with the target object and makes human-computer interaction more natural, thereby improving interaction experience.

According to the technical solutions disclosed in the embodiments of the present application, a gaze point of a line of sight of a user on any target object in a virtual space is determined, based on an interaction gesture for the gaze point, a display form of the gaze point is adjusted to generate a first interaction point, and then interaction with the target object is performed based on the first interaction point, so that the interaction with the target object can be performed without relying on an interaction apparatus, which improves flexibility of the interaction with the target object, makes human-computer interaction more natural, and can also enhance diversity and interestingness of human-computer interaction, thereby improving atmosphere and interaction experience of human-computer interaction.

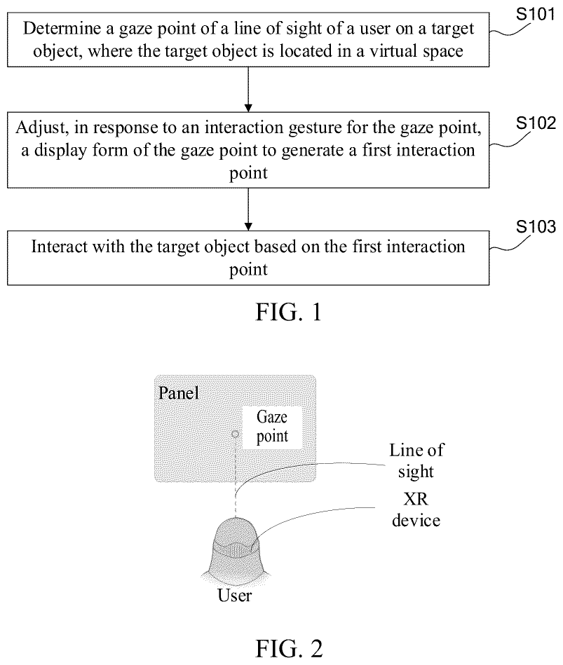

FIG. 1 is a flowchart of a human-computer interaction method according to an embodiment of the present application. The human-computer interaction method provided in this embodiment of the present application may be performed by a human-computer interaction apparatus. The human-computer interaction apparatus may be formed by hardware and/or software, and may be integrated into an electronic device. In the present application, the electronic device may be various types of terminal devices that can provide virtual spaces, such as a VR device, an AR device, an MR device, or an XR device. It should be understood that the electronic device may also be referred to as user equipment, a user apparatus, a terminal device, or the like. The electronic device is not limited herein. In order to facilitate the description of the technical solution provided in the present application, description is made in detail below by using an example in which the electronic device is an XR device.

As shown in FIG. 1, the method includes the following steps.
S101: Determine a gaze point of a line of sight of a user on a target object, where the target object is located in a virtual space.

In the present application, the virtual space is any target virtual space selected from a plurality of virtual spaces provided by an XR device by a user using the XR device, or may be a virtual scene that combines virtuality with reality, that allows human-computer interaction, that is constructed by the user through the XR device based on an own requirement. The virtual space is not limited herein.

Moreover, at least one virtual object may be provided in the virtual space, so that the user can perform various interactive operations with any virtual object. Optionally, the virtual object is, but not limited to, an application interface, a function control in an application interface, an object, a virtual character, and a virtual object displayed in an application interface, or the like. In the present application, the application interface may be a window or a panel. The application interface is not limited herein.

The virtual object presented in the virtual space may be 2-dimensional or 3-dimensional, which is not limited in the present application.

The gaze point may be understood as a focus position of the line of sight of the user on any virtual object in the virtual space that represents the user's gaze. In this embodiment of the present application, the gaze point of the line of sight of the user may be displayed in a form of a halo, a form of a hollow circle, another display form, or the like.

When the user wants to interact with an object, the line of sight of the user may be directed at a specific position point on the object. Therefore, in the present application, the line of sight of the user may be tracked, and a virtual object in the virtual space that the user focuses eyes on is determined based on the line of sight of the user, and then the virtual object that the user focuses eyes on may be determined to be a target object to interact with.

In some optional embodiments, after the user wears the XR device and enters a virtual space, a line-of-sight tracking camera on the XR device may acquire an eye image of the user in real time. Next, the XR device may analyze and process the eye image acquired by the tracking camera to obtain eye movement data of the user. Then, user light-of-sight direction information may be determined based on the eye movement data, thereby determining the gaze point of the line of sight of the user based on the user line-of-sight direction information. When it is determined that the gaze point of the line of sight of the user is positioned on a virtual object in the virtual space, it indicates that the user needs to interact with the target object. In this case, the virtual object may be determined to be a target object that the user needs to interact with.

For example, as shown in FIG. 2, when the gaze point of the line of sight of the user tracked is located on a panel in the virtual space, the panel may be determined to be a target object in this case, and the gaze point of the line of sight of the user is displayed on the panel in the form of a hollow circle.
S102: Adjust, in response to an interaction gesture for the gaze point, a display form of the gaze point to generate a first interaction point.

After the target object that the user needs to interact with is determined based on the line of sight of the user, the user may trigger, through a predefined gesture, generation of the first interaction point based on the gaze point, so as to lay a foundation for the operation of interacting with the target object.

The predefined gesture may be set based on adaptability between a gesture operation habit of the user in a real scene and an object interactive operation. For example, when a determined event is triggered, the predefined gesture may be a one-hand pinch gesture or the like, which is not limited in the present application.

When the first interaction point is generated, in the present application, a user gesture image may be acquired in real time by an image acquisition apparatus on the XR device, and the user gesture image is recognized by a gesture recognition technology to obtain a gesture recognition result. When it is determined that the gesture recognition result is a first gesture that triggers generation of the first interaction point based on the gaze point, the display form of the gaze point is switched from a first form to a second form based on the first gesture, and the gaze point in the second form is determined to be the first interaction point. In the present application, optionally, the image acquisition apparatus is a camera on the XR device and configured to acquire an environment image of a real environment where the user is located.

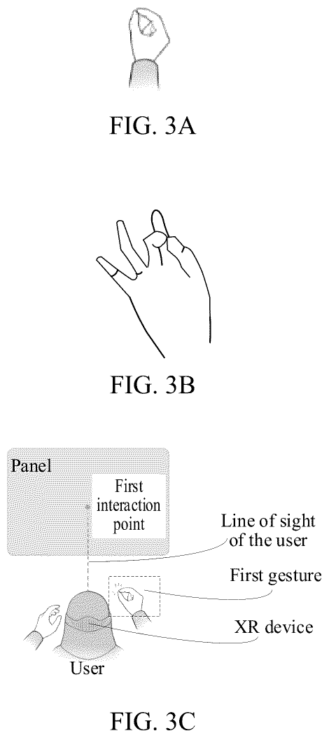

The first gesture may be understood as a predefined gesture that triggers generation of the first interaction point based on the gaze point. In some optional implementations, the first gesture may be shown in FIG. 3a and FIG. 3b, which is a one-hand pinch gesture formed by bringing a thumb of a real hand and any of other fingers together. A point of contact between the thumb and any finger is a finger pinch point in the one-hand pinch gesture. The above other fingers may be understood as the remaining fingers other than the thumb, which are specifically an index finger, a middle finger, a ring finger, and a little finger.

That is, when gesture recognition is performed on the user gesture image, there is only a need to identify whether the thumb and any finger are brought together. When it is identified that the thumb and any finger are brought together, a gesture result may be determined to be a one-hand pinch gesture.

Still taking the first gesture shown in FIG. 3a as an example, assuming that the first gesture that generates the first interaction point based on the gaze point is a one-hand pinch gesture, when the image acquisition apparatus on the XR device acquires the user gesture image and recognizes that a gesture recognition result of the user gesture image is a one-hand pinch gesture, the gaze point on the target object is switched from a form of a hollow circle to a form of a solid circle, and the form of the solid circle is determined to be the generated first interaction point, as shown in FIG. 3c.
S103: Interact with the target object based on the first interaction point.

In the present application, the interacting with the target object based on the first interaction point includes various options, optionally including: at least one of moving the target object, zooming out the target object, zooming in the target object, rotating the target object, and closing the target object. Moving may be understood as dragging. That is, the target object is moved from a current display position to another display position.

That is, in the present application, the target object may be dragged, zoomed in, zoomed out, rotated, and/or closed by controlling the first interaction point on the target object.

It may be understood that, in the present application, the target object that the user wants to interact with is determined by tracking the line of sight of the user, and then the gaze point of the line of sight of the user on the target object is triggered based on the interaction gesture to generate the first interaction point, thereby performing, based on the first interaction point, various operations of interacting with the target object. In this way, the line of sight of the user can be used for navigation and the interactive operation is triggered by a user gesture to interact with the virtual object in the virtual space, so that reliance on an interaction apparatus can be eliminated, achieving more natural interaction with the virtual object based on an interaction habit of the user in a real scene, and improving interaction experience.

According to the technical solutions provided in this embodiment of the present application, the gaze point of the line of sight of the user on any target object in the virtual space is determined, based on the interaction gesture for the gaze point, the display form of the gaze point is adjusted to generate the first interaction point, and then interaction with the target object is performed based on the first interaction point, so that the interaction with the target object can be performed without relying on an interaction apparatus, which improves flexibility of the interaction with the target object, makes human-computer interaction more natural, and can also enhance diversity and interestingness of human-computer interaction, thereby improving atmosphere and interaction experience of human-computer interaction.

As an optional implementation of the present application, in the present application, the interaction with the target object may include: at least one of dragging, zooming in, zooming out, or rotating. In order to more clearly describe each interaction with the target object based on the first interaction point, an interaction process for each interaction is specifically described below.

### Case 1: The Target Object is Dragged Based on the First Interaction Point.

In some optional embodiments, after the first interaction point is generated, the image acquisition apparatus on the XR device in the present application may continue to acquire a user gesture image in real time, and the user gesture image is constantly recognized by using the gesture recognition technology, to obtain a gesture recognition result. When it is determined that an interaction gesture acting on the first interaction point is the first gesture and the first gesture moves from a first position to a second position, the target object is controlled based on a movement trajectory of the first gesture to move from the first position to the second position, so as to implement dragging of the target object.

The first position may be understood as a current display position of the first interaction point or an initial position of the first interaction point corresponding to a real hand of the user, and the second position may be understood as a new display position after dragging based on the first gesture or a position of the first interaction point corresponding to the real hand of the user after movement.

It should be understood that the initial position of the first interaction point corresponding to the real hand of the user corresponds to the current display position of the first interaction point, and the position of the first interaction point corresponding to the real hand of the user after movement corresponds to the new display position of the first interaction point.

As an optional implementation, in the present application, the target object is controlled based on the movement trajectory of the first gesture to move from the first position to the second position. Specifically, an initial position (i.e., the first position) where the real hand of the user makes the first gesture may be determined through the gesture recognition technology and based on the user gesture image acquired by the image acquisition apparatus in real time, and the initial position may be mapped to the target object. With the movement of the real hand of the user making the first gesture, the second position of the first gesture is obtained, and the second position is mapped to the target object, to obtain a new display position of the target object after dragging.

It should be understood that since the first interaction point is located on the target object and is bound to the target object, the first interaction point moving with the first gesture means the target object moving with the first gesture. Correspondingly, a movement position of the first gesture being mapped to the target object means the movement position of the first gesture being mapped to the first interaction point.

When a movement position of the real hand of the user is mapped to the target object, the new display position of the target object may be determined through dynamic fitting based on a speed, an acceleration, and a movement distance during the movement of the real hand of the user and/or a distance between the real hand of the user and the target object.

In the present application, the speed, the acceleration, and the movement distance during the movement of the real hand of the user may be determined based on a plurality of frames of continuous gesture images acquired by the image capturing apparatus. A specific determination process is a conventional technology, which is not described in detail herein.

It should be understood that, in the present application, the new display position of the target object is determined based on the movement distance during the movement of the real hand of the user. Optionally, a shorter movement distance of the real hand of the user indicates that a projection distance mapped to the target object is closer to an actual movement distance of the real hand of the user.

In addition, the new display position of the target object being determined through dynamic fitting based on a distance between the real hand of the user and the target object may be performed based on the following: Specifically, a shorter distance between the real hand of the user and the target object indicates that a position on the target object to which a position of the real hand of the user is mapped is closer to the position of the real hand of the user. In contrast, a longer distance between the real hand of the user and the target object indicates that the position on the target object to which the position of the real hand of the user is mapped is farther away from the position of the real hand of the user. That is, when the real hand of the user is closer to the target object, the position on the target object to which the position of the real hand of the user is mapped is closer to mapping in a same proportion. In contrast, when the real hand of the user is farther away from the target object, the position on the target object to which the position of the real hand of the user is mapped is not mapping in a same proportion.

As an optional implementation, in the present application, based on the speed during the movement of the real hand of the user, determining the new display position of the target object when the position of the real hand of the user is mapped to the target object may be implemented by the following formula:

$$W = a + b \cdot {v}^{n}$$

where W denotes the new display position of the target object when the position of the real hand of the user is determined based on the movement speed of the real hand of the user and the position is mapped to the target object; a, b, and n are adjustable parameters, which may be flexibly adjusted according to a specific application and a user operation habit; and v denotes the movement speed of the real hand of the user.

Based on the above formula, it may be learned that when the movement speed of the real hand of the user is higher, a distance between the new display position of the target object and an initial display position before dragging also increases accordingly. In this way, when the real hand of the user moves at a high speed, a corresponding movement distance of the target object may also be longer, so as to improve a degree of restoration of the interactive operation on the target object.

It may be understood that after the first interaction point is generated based on the first gesture, the first gesture made by the real hand of the user has not stopped, which indicates that this real hand has a control right of controlling the first interaction point to interact with the target object. That is, as the real hand of the user making the first gesture moves, the first interaction point may also drive the target object to move accordingly.

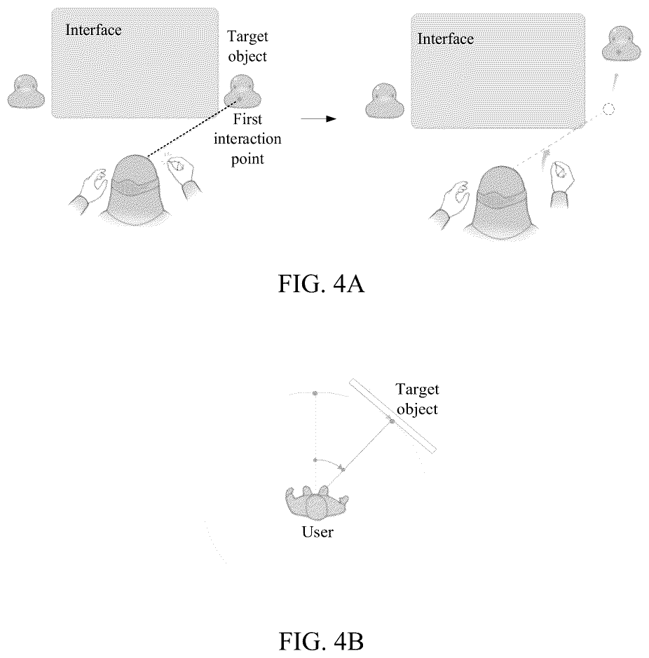

Therefore, when the real hand of the user makes the first gesture and moves from a current position to a new position, the target object where the first interaction point is located may also moves from a current display position to a new display position along with the movement trajectory of the first gesture. For a specific dragging process, reference may be made to FIG. 4a. The current display position of the target object corresponds to the initial position of the real hand of the user making the first gesture, and the new display position of the target object corresponds to the position after the real hand of the user making the first gesture moves.

Considering that the virtual space is a three-dimensional space, when the user controls the first interaction point based on the first gesture to drag the target object, a maximum translation angle of the real hand of the user generally does not exceed a preset angle threshold. In the present application, the preset angle threshold may be determined based on the maximum translation angle when the real hand of the user translates normally in a real environment. For example, the preset angle threshold is optionally 100 degrees, 120 degrees, 140 degrees, or the like, which is not limited herein. That is, when a translation angle of the real hand of the user is greater than the preset angle threshold, the real hand of the user may rotate by using an elbow as a center point.

Therefore, in the present application, when the first interaction point is controlled based on the first gesture to drag the target object, the translation angle of the real hand of the user during the movement of the real hand of the user making the first gesture is determined based on a gesture image. Next, it is determined whether the translation angle is greater than the preset angle threshold. If the translation angle is greater than the preset angle threshold, when the target object is dragged, by using the user as a center point, the target object is further controlled to rotate on the basis of translating the target object, so that the target object is always facing the user. Refer to FIG. 4b for details. If the translation angle is less than or equal to the preset angle threshold, it indicates that the real hand of the user does not rotate. In this case, the target object is only translated based on the movement of the real hand of the user. For a specific process, reference may be made to FIG. 4a above.

In some optional embodiments, in consideration of a limited field of view of the user, when the user wears the XR device to turn the head of the user, in order to ensure that the target object can always be displayed in the field of view of the user, the XR device may dynamically adjust displayed content of the virtual space based on a turning angle of the head of the user. That is, in the present application, a posture of the head of the user may be determined through data acquired by an inertial measurement unit (IMU) and/or the image acquisition apparatus in the XR device. When it is determined that the posture of the head of the user changes, the target object in the virtual space is dynamically adjusted based on the changed posture of the head, so that the target object is always within the field of view of the user, thereby implementing user-centered control over the display of the target object.

Case 2: The Target Object is Zoomed in, Zoomed Out, and/or Rotated Based on the First Interaction Point.

In some optional embodiments, the target object being zoomed in, zoomed out, and/or rotated may include steps S11 to S14 below.
Step S11: When it is determined that an interaction gesture acting on the first interaction point is switched from the first gesture to a second gesture and the second gesture moves from a first position to a third position, control, based on a movement trajectory of the second gesture, the first interaction point to move from the first position to the third position.
Step S12: Zoom in the target object when the third position is on a zoom-in control and the interaction gesture on the first interaction point is switched from the second gesture to a third gesture.
Step S13: Zoom out the target object when the third position is on a zoom-out control and the interaction gesture on the first interaction point is switched from the second gesture to the third gesture.
Step S14: Rotate the target object when the third position is on a rotate control and the interaction gesture on the first interaction point is switched from the second gesture to the third gesture.

In the present application, the first position may be understood as a current display position of the first interaction point or an initial position of the first interaction point corresponding to a real hand of the user, and the second position may be understood as a new display position after following the movement of the second gesture or a position of the first interaction point corresponding to the real hand of the user after movement.

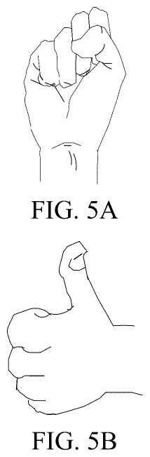

The second gesture may be a predefined gesture, and the gesture is different from the first gesture. For example, the second gesture may be shown in FIG. 5a, in which five fingers of the real hand of the user are bent towards the palm to form a first gesture. In another example, the second gesture may be shown in FIG. 5b, in which the thumb of the real hand is up, and the remaining four fingers are bent towards the palm to form a thumbs-up gesture. Certainly, the second gesture may alternatively be another gesture different from the first gesture. A specific form of the second gesture is not limited herein.

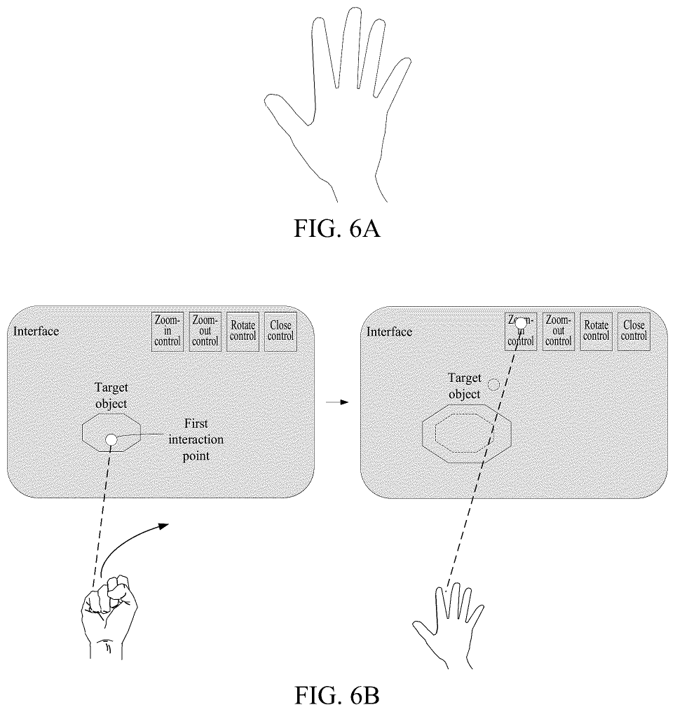

The third gesture may also be a predefined gesture, and the gesture is different from both the first gesture and the second gesture. For example, the third gesture may be shown in FIG. 6a, in which the real hand of the user is in a spread posture, or another gesture that is different from the first gesture and the second gesture.

In some optional embodiments, after the first interaction point is generated based on the gaze point, the image acquisition apparatus on the XR device may continuously acquire a user gesture image, and the user gesture image is constantly recognized, to obtain a gesture recognition result. When it is recognized that a gesture in the user gesture image changes from the first gesture to the second gesture, it indicates that the user needs to independently control the first interaction point based on the second gesture to interact with the target object. Optionally, interacting with the target object includes zooming in, zooming out, rotating, and/or closing the target object.

Therefore, in the present application, a user gesture image may continue to be acquired, and the user gesture image is recognized. When it is recognized that a gesture in the gesture image is a second gesture and the second gesture moves from a first position to a third position, the first interaction point may be controlled based on the movement trajectory of the second gesture to move from the first position to the third position. Next, it is determined whether the third position where the first interaction point is located is on a zoom-in control, a zoom-out control, a rotate control, or a close control. The target object is zoomed in when it is determined that the third position where the first interaction point is located is on the zoom-in control and the interaction gesture on the first interaction point changes from the second gesture to a third gesture, as shown in FIG. 6b. The target object is zoomed out when it is determined that the third position where the first interaction point is located is on the zoom-out control and the interaction gesture on the first interaction point changes from the second gesture to the third gesture. The target object is rotated when it is determined that the third position where the first interaction point is located is on the rotate control and the interaction gesture on the first interaction point changes from the second gesture to the third gesture. The target object is closed when it is determined that the third position where the first interaction point is located is on the close control and the interaction gesture on the first interaction point changes from the second gesture to the third gesture.

That is, in the present application, a gesture action made by the real hand of the user is recognized in real time, and when it is recognized that the gesture made by the real hand of the user is switched from the first gesture to the second gesture, it indicates that the user needs to trigger obtaining of independent control over the first interaction point through the second gesture. Then, after obtaining the independent control over the first interaction point based on the second gesture, the user may move the real hand of the user that makes the second gesture, to control the first interaction point to move accordingly following the movement of the second gesture. Then, when controlling the first interaction point to move to a target interaction control, the user may switch the second gesture made by the real hand to a third gesture to trigger an interaction determination event through the third gesture, which is similar to left-click, by using a mouse, to trigger the determination event or touch and click a confirm control to trigger the determination event, so that the XR device can execute, based on the recognized third gesture, an interaction event corresponding to the target interaction control where the first interaction point is located, to implement the operation of interacting with the target object.

The target interaction control may be understood as a control configured to perform a corresponding interactive operation on the target object, such as a zoom-in control, a zoom-out control, a rotate control, or a close control.

In some optional embodiments, after the first interaction point is generated based on the gaze point, the line-of-sight tracking camera on the XR device in the present application may continue to acquire an eye image of the user in real time. Then, the XR device analyzes the eye image acquired by the line-of-sight tracking camera to determine whether eyes of the user are focused on the first interaction point for preset duration. When it is determined that the eyes of the user are focused on the first interaction point for the preset duration, it indicates that the user needs to independently control the first interaction point through eye movement interaction to perform various interactions with the target object. For example, the target object is zoomed in, zoomed out, rotated, and/or closed. The preset duration may be flexibly set according to an actual application requirement. For example, the preset duration may be set to 2 seconds, 3 seconds, or the like.

As an optional implementation, when it is determined, based on the eye image of the user, that the user needs to control the first interaction point through eye movement interaction to interact with the target object, in the present application, the eye image of the user may be continuously acquired by the line-of-sight tracking camera to determine a movement trajectory of the line of sight of the user based on the user eye image, thereby controlling the first interaction point based on the movement trajectory to move. When the position of the first interaction point after the movement is on the zoom-in control, the zoom-out control, the rotate control, or the close control and a time length when the eyes of the user are focused on the control where the first interaction point is located reaches the preset duration, the operation of interacting with the target object is performed based on an interaction time corresponding to the control where the first interaction point is located.

That is, in the present application, it may be determined, based on the eye image of the user acquired by the line-of-sight tracking camera, whether the user obtains independent control over the first interaction point through eye movement interaction. When it is determined that the user obtains independent control over the first interaction point through eye movement interaction, in the present application, the eye image of the user may be continuously acquired by the line-of-sight tracking camera, and the first interaction point is controlled based on the acquired user eye image to move. When the first interaction point moves to any target interaction control, the target interaction control may be triggered based on the user eye image to execute a corresponding interaction event, so as to interact with the target object.

In some optional embodiments, the user may interact with the virtual object by voice. Therefore, in the present application, after the first interaction point is generated based on the interaction gesture, interactive voice sent by the user may be further obtained, and interacts with the target object may be performed based on the interactive voice.

Optionally, after the first interaction point is generated, if the user wants to interact with the target object where the first interaction point is located, the interactive voice may be input, so that the XR device can perform voice recognition on the interactive voice acquired by a voice acquisition apparatus such as a microphone. When it is recognized that the interactive voice output by the user is to drag the target object, the target object is dragged based on the interactive voice of dragging. For example, the interactive voice is optionally “Drag XX to the right by 2 cm” or the like. When it is recognized that the interactive voice output by the user is to zoom in the target object, the target object is zoomed in based on the interactive voice of zooming in. For example, the interactive voice is optionally “Zoom in XX”, “Zoom in XX by 1 times”, or the like. When it is recognized that the interactive voice output by the user is to zoom out the target object, the target object is zoomed out based on the interactive voice of zooming out. When it is recognized that the interactive voice output by the user is to close the target object, the target object is closed based on the interactive voice of closing. For example, the interactive voice is optionally “Close XX” or the like.

It should be noted that, in the present application, when the user inputs the interactive voice, the user may stop the real hand of the user from making a first gesture action, or may not stop the real hand of the user from making the first gesture action, which is not limited in the present application. That is, the user may input the interactive voice when generating the first interaction point based on the first gesture and stopping making the first gesture action, or input the interactive voice when maintaining the first gesture after generating the first interaction point based on the first gesture. It should be understood that, in the present application, the interactive voice input by the user may independently control the first interaction point to interact with the target object, or may be combined with the interaction gesture to control the first interaction point to interact with the target object. Therefore, voice interaction can be combined with eye movement interaction and gesture interaction to achieve natural and intuitive interaction with the target object based on multi-modal interaction, thereby increasing diversity and interestingness of human-computer interaction and further enriching human-computer interaction modes.

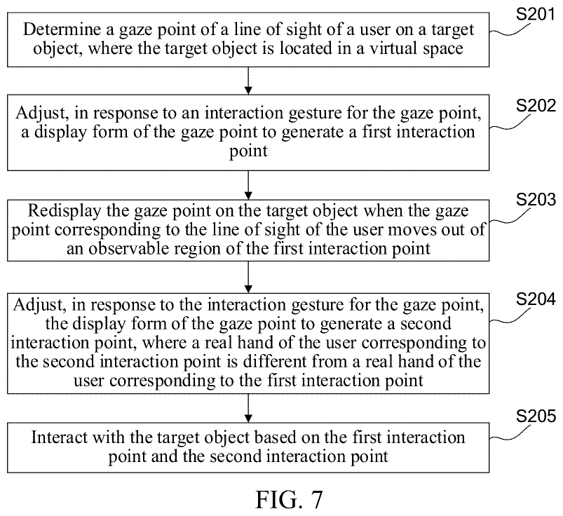

In some optional implementation scenarios, a corresponding interaction gesture needs to be set for each interactive operation in the case of interaction with the virtual object in the virtual space based on a single interaction point. Therefore, in order to prevent impact of excessive interaction gestures on convenience of interaction with the virtual object, in the present application, a plurality of interaction points may be generated on the target object to facilitate convenient interaction with the target object based on the plurality of interaction points. A process of interacting with an object in the virtual space based on a plurality of interaction points provided in the present application is specifically described below with reference to FIG. 7. As shown in FIG. 7, the method may include the following steps.
S201: Determine a gaze point of a line of sight of a user on a target object, where the target object is located in a virtual space.
S202: Adjust, in response to an interaction gesture for the gaze point, a display form of the gaze point to generate a first interaction point.
S203: Redisplay the gaze point on the target object when the gaze point corresponding to the line of sight of the user moves out of an observable region of the first interaction point.

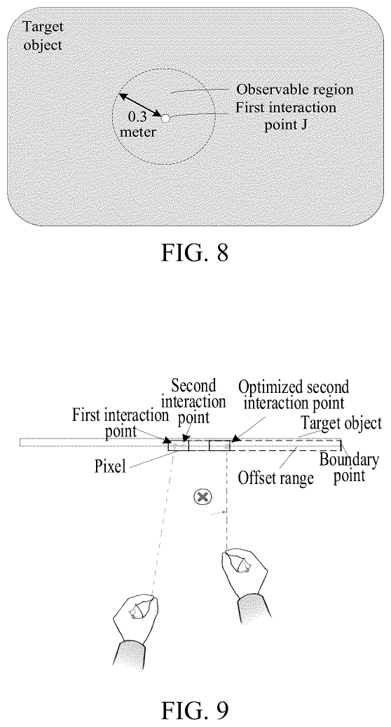

In the present application, the observable region may be a region for observation determined by using the first interaction point as a center point. The region may be a circular region or a region in another shape, which is not limited in the present application. When the observable region is a circular region, the circular region may be determined by using the first interaction point as a center point and a preset distance as a radius. The preset distance is an adjustable parameter and may be specifically dynamically adjusted based on a user eye gaze range, which is not limited in the present application. For example, assuming that a first interaction point J on the target object is (x, y) and the preset distance is 0.3 meter, a circular observable region determined by using the first interaction point J (x, y) as a center point and the preset distance of 0.3 m as a radius may be shown in FIG. 8.

In order to interact with the target object based on a plurality of interaction points, in the present application, after the first interaction point is generated, the line of sight of the user may move out of the observable region of the first interaction point and then the user looks at another position of the target object to generate a second interaction point. At the same time, the XR device may acquire an eye image of the user in real time based on the line-of-sight tracking camera and analyze the eye image. When it is determined, based on the eye image, that the line of sight of the user moves out of the observable region of the first interaction point, in the present application, the gaze point corresponding to the line of sight of the user may be redisplayed, so that the user generates the second interaction point based on the displayed gaze point.

That is, when the user sees the redisplayed gaze point again, the user may generate the second interaction point based on the redisplayed gaze point. In this way, a plurality of interaction points are generated based on the gaze point of the line of sight of the user, thereby laying a foundation for subsequent convenient interaction with the target object based on the plurality of interaction points.
S204: Adjust, in response to the interaction gesture for the gaze point, the display form of the gaze point to generate a second interaction point, where a real hand of the user corresponding to the second interaction point is different from a real hand of the user corresponding to the first interaction point.

A specific process of adjusting the display form of the gaze point to generate the second interaction point is the same as or similar to the foregoing process of generating the first interaction point, which is not described in detail herein.

It should be understood that, in the present application, the real hand of the user corresponding to generating the first interaction point is different from the real hand of the user corresponding to generating the second interaction point. Optionally, when the real hand of the user corresponding to generating the first interaction point is the left hand of the user, the real hand of the user corresponding to generating the second interaction point is the right hand of the user. Alternatively, when the real hand of the user corresponding to generating the first interaction point is the right hand of the user, the real hand of the user corresponding to generating the second interaction point is the left hand of the user.

In some optional embodiments, the redisplayed gaze point may follow the line of sight of the user and stay close to the first interaction point. For example, the gaze point stays at a position where the first interaction point is located. If the user inputs an interaction gesture in this case and adjusts the display form of the gaze point based on the interaction gesture to generate the second interaction point, since the first interaction point and the second interaction point are close to each other, the interactive operation on the target object cannot be completed based on the first interaction point and the second interaction point.

In view of this, in the present application, when the second interaction point is generated based on the interaction gesture, it may be determined whether a display position of the second interaction point is the same as a display position of the first interaction point. If the display positions are the same, it indicates that the second interaction point is close to the first interaction point. In this case, the display position of the second interaction point is optimized, so that the optimized second interaction point and the first interaction point are located at different display positions respectively.

In some optional embodiments, when the display position of the second interaction point is optimized, the real hand of the user corresponding to the second interaction point is first determined, and an offset direction of the second interaction point is determined based on a relative position of the real hand of the user. Next, an offset is determined based on a minimum unit corresponding to the display position and a boundary point of the target object on the side of the offset direction. Then, the display position of the second interaction point is shifted based on the offset direction and the offset, so that the second interaction point after the shift is at a distance from the first interaction point, and the second interaction point and the first interaction point are not at a same display position.

In the present application, the offset direction of the second interaction point being determined based on the relative position of the real hand of the user is specifically as follows: When the real hand of the user corresponding to the second interaction point is the right hand of the user, the relative position of the real hand of the user is a right side, and then the offset direction of the second interaction point is the right side. When the real hand of the user corresponding to the second interaction point is the left hand of the user, the relative position of the real hand of the user is a left side, and then the offset direction of the second interaction point is the right side.

In addition, the offset being determined based on the minimum unit corresponding to the display position and the boundary point of the target object on one side of the offset direction is optionally as follows: When the minimum unit is a pixel, an offset range is determined by using any pixel on the left or right adjacent to a pixel where the first interaction point is located as a minimum offset and a boundary pixel corresponding to the adjacent pixel as a maximum offset. Then, any offset is selected from the offset range as the offset of the second interaction point.

For example, as shown in FIG. 9, assuming that the display position where the second interaction point is to be displayed is at the display position of the first interaction point, the offset direction of the second interaction point is determined to be the right side based on the real hand of the user corresponding to the second interaction point. Moreover, if the offset range is determined based on the minimum unit corresponding to the display position and the boundary point on the right of the target object to be a dashed box portion in the figure, an offset at a distance of 2 from the display position of the first interaction point may be selected from the offset range. Then, the second interaction point is shifted to the right by an offset of 2, so that the shifted second interaction point is located at a position on the right of the first interaction point and at a distance of an offset of 2. The minimum unit in FIG. 9 is a pixel.

It should be understood that, in the present application, only the second interaction point after optimization is displayed, and the second interaction point before the optimization is not displayed, so that the optimization of the second interaction point is imperceptible to the user.
S205: Interact with the target object based on the first interaction point and the second interaction point.

In the present application, the interacting with the target object includes: at least one of moving, zooming in, zooming out, or rotating.

In some optional embodiments, for the interacting with the target object, an interaction gesture acting on the first interaction point and an interaction gesture acting on the second interaction point may be first determined. When it is determined that the interaction gesture acting on the first interaction point and the interaction gesture acting on the second interaction point both are the first gesture, the first interaction point and the second interaction point are controlled based on the movement trajectory of the first gesture to move. The movement trajectory of the first gesture is specifically the movement trajectory of the first gesture acting on the first interaction point and the movement trajectory of the first gesture acting on the second interaction point.

Then, the target object is moved based on the first interaction point and the second interaction point when both a movement variation amount and a movement direction of the first interaction point are the same as those of the second interaction point. The target object is zoomed in, zoomed out, or rotated based on the first interaction point and the second interaction point when the movement directions of the first interaction point and the second interaction point are different.

In the present application, the target object being moved, zoomed, and/or rotated based on the first interaction point and the second interaction point may be the target object being moved, zoomed, and/or rotated based on a center point of a line segment between the first interaction point and the second interaction point as a reference point. Alternatively, the target object may be moved, zoomed, and/or rotated based on a changed display position of the first interaction point and/or a changed display position of the second interaction point, which is not limited in the present application.

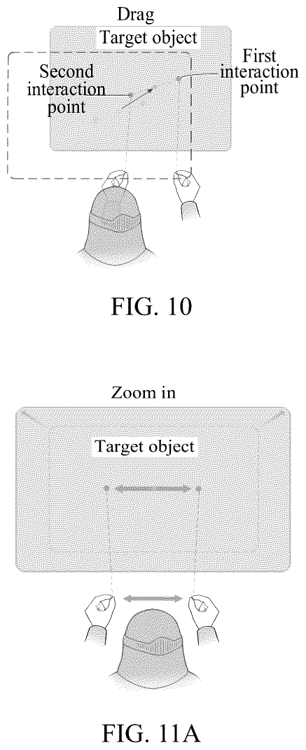

Since the movement directions and the movement variations of the first interaction point and the second interaction point are the same when the target object is moved based on the first interaction point and the second interaction point, in the present application, the target object is moved when it is determined that both the movement variation amount and the movement direction of the first interaction point are the same as those of the second interaction point. For example, FIG. 10 is a schematic diagram of moving the target object based on a center point of a line segment between the first interaction point and the second interaction point. For the center point of the line segment between the first interaction point and the second interaction point, an average value may be calculated based on the display position of the first interaction point and the display position of the second interaction point, and the average value may be used as a position of the center point of the line segment.

In some optional embodiments, when the movement directions of the first interaction point and the second interaction point are different, it may indicate that the user needs to zoom or rotate the target object regardless of whether movement distances for the first interaction point and the second interaction point are the same. Then, in the present application, the target object may be zoomed or rotated based on the first interaction point and the second interaction point.

As an optional implementation, the target object being zoomed or rotated based on the first interaction point and the second interaction point may include the following steps.
Step 1: Determine whether the length of the line segment between the first interaction point and the second interaction point is greater than an initial length. The initial length is a length of the line segment between the first interaction point and the second interaction point before the first interaction point and the second interaction point are controlled based on the first gesture to move.
Step 2: Zoom in the target object based on the first interaction point and the second interaction point when it is determined that the length of the line segment between the first interaction point and the second interaction point is greater than the initial length.
Step 3: Zoom out the target object based on the first interaction point and the second interaction point when it is determined that the length of the line segment between the first interaction point and the second interaction point is less than the initial length.
Step 4: Rotate the target object based on the first interaction point and the second interaction point when it is determined that the length of the line segment between the first interaction point and the second interaction point is equal to the initial length.

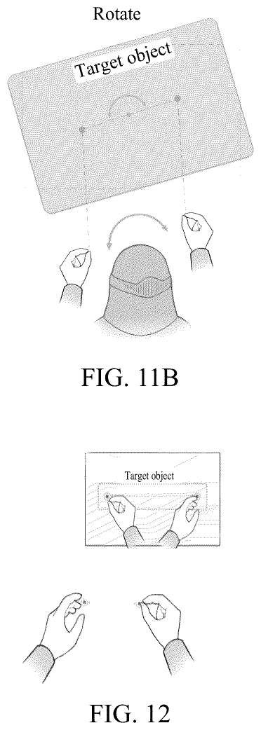

FIG. 11a shows that the target object is zoomed in based on the center point of the line segment between the first interaction point and the second interaction point. FIG. 11b shows that the target object is rotated based on the center point of the line segment between the first interaction point and the second interaction point.

In some optional embodiments, two virtual hands corresponding to two real hands of the user may be displayed in the virtual space. However, when a matching relationship between the virtual hands and the real hands of the user is wrong, a problem of first zooming in and then zooming out or first zooming out and then zooming in (as shown in FIG. 12) may occur when the real hand of the user is used to drive the corresponding virtual hand to control the first interaction point and the second interaction point to zoom the target object. In this regard, in the present application, when the target object is zoomed by using the virtual hand to control the first interaction point and the second interaction point, an interaction point corresponding to each real hand of the user is first determined, and then the first interaction point and the second interaction point are controlled to move correspondingly based on a movement trajectory of the real hand of the user to achieve accurate zooming of the target object. Therefore, by ignoring the virtual hand, the problem of a deviation in the zooming of the virtual object caused by using the real hand to drive the wrong matching virtual hand due to a wrong matching relationship between the virtual hand and the real hand can be avoided.

According to the technical solutions provided in this embodiment of the present application, the gaze point of the line of sight of the user on any target object in the virtual space is determined, based on the interaction gesture for the gaze point, the display form of the gaze point is adjusted to generate the first interaction point, and then interaction with the target object is performed based on the first interaction point, so that the interaction with the target object can be performed without relying on an interaction apparatus, which improves flexibility of the interaction with the target object, makes human-computer interaction more natural, and can also enhance diversity and interestingness of human-computer interaction, thereby improving atmosphere and interaction experience of human-computer interaction.

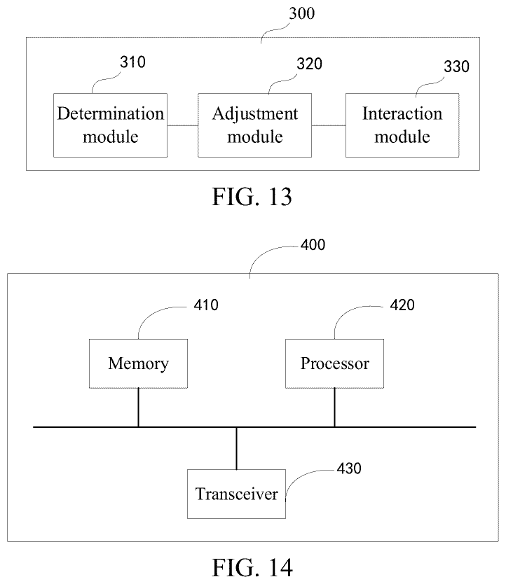

A human-computer interaction apparatus according to an embodiment of the present application is described below with reference to FIG. 13. FIG. 13 is a schematic block diagram of a human-computer interaction apparatus according to an embodiment of the present application.

As shown in FIG. 13, the human-computer interaction apparatus 300 includes: a determination module 310, an adjustment module 320, and an interaction module 330.

The determination module 310 is configured to determine a gaze point of a line of sight of a user on a target object, where the target object is located in a virtual space.

The adjustment module 320 is configured to adjust, in response to an interaction gesture for the gaze point, a display form of the gaze point to generate a first interaction point.

The interaction module 330 is configured to interact with the target object based on the first interaction point.

In an optional implementation of this embodiment of the present application, the adjustment module 320 is specifically configured to:
recognize an obtained gesture image to obtain a gesture recognition result, where the gesture image is acquired by an image acquisition apparatus, and the gesture image corresponds to a left hand of the user or a right hand of the user; and
switch, when the gesture recognition result is a first gesture, the display form of the gaze point from a first form to a second form based on the first gesture, and determine the gaze point in the second form to be the first interaction point.

In an optional implementation of this embodiment of the present application, the interaction module 330 is specifically configured to:
when it is determined that an interaction gesture acting on the first interaction point is the first gesture and the first gesture moves from a first position to a second position, control, based on a movement trajectory of the first gesture, the target object to move from the first position to the second position.

In an optional implementation of this embodiment of the present application, the interaction module 330 is specifically configured to:
when it is determined that an interaction gesture acting on the first interaction point is switched from the first gesture to a second gesture and the second gesture moves from a first position to a third position, control, based on a movement trajectory of the second gesture, the first interaction point to move from the first position to the third position;
zoom in the target object when the third position is on a zoom-in control and the interaction gesture on the first interaction point is switched from the second gesture to a third gesture;
zoom out the target object when the third position is on a zoom-out control and the interaction gesture on the first interaction point is switched from the second gesture to the third gesture; and
rotate the target object when the third position is on a rotate control and the interaction gesture on the first interaction point is switched from the second gesture to the third gesture.

In an optional implementation of this embodiment of the present application, the interaction module 330 is specifically configured to:
when interactive voice is obtained, interact with the target object based on the interactive voice.

In an optional implementation of this embodiment of the present application, the interaction module 330 is further configured to:
recognize the interactive voice to obtain a voice recognition result;
move the target object based on the voice recognition result when the voice recognition result is to move the target object;
zoom in the target object based on the voice recognition result when the voice recognition result is to zoom in the target object;
zoom out the target object based on the voice recognition result when the voice recognition result is to zoom out the target object; and
rotate the target object based on the voice recognition result when the voice recognition result is to rotate the target object.

In an optional implementation of this embodiment of the present application, the apparatus 300 further includes:
a display module configured to redisplay the gaze point on the target object when the gaze point corresponding to the line of sight of the user moves out of an observable region of the first interaction point, where
the adjustment module is further configured to adjust, in response to the interaction gesture for the gaze point, the display form of the gaze point to generate a second interaction point, where a real hand of the user corresponding to the second interaction point is different from a real hand of the user corresponding to the first interaction point; and
the interaction module is further configured to interact with the target object based on the first interaction point and the second interaction point.

In an optional implementation of this embodiment of the present application, the interacting with the target object includes: at least one of moving, zooming in, zooming out, or rotating.

In an optional implementation of this embodiment of the present application, the interaction module includes:
a control unit configured to, when it is determined that an interaction gesture acting on the first interaction point and an interaction gesture acting on the second interaction point both are a first gesture, control, based on a movement trajectory of the first gesture, the first interaction point and the second interaction point to move; and
a processing unit configured to move the target object based on the first interaction point and the second interaction point when both a movement variation amount and a movement direction of the first interaction point are the same as those of the second interaction point; and
zoom in, zoom out, or rotate the target object based on the first interaction point and the second interaction point when the movement directions of the first interaction point and the second interaction point are different.

In an optional implementation of this embodiment of the present application, the processing unit is specifically configured to:
zoom in the target object based on the first interaction point and the second interaction point when it is determined that a length of a line segment between the first interaction point and the second interaction point is greater than an initial length, where the initial length is a length of a line segment between the first interaction point and the second interaction point before the first interaction point and the second interaction point are controlled based on the first gesture to move;
zoom out the target object based on the first interaction point and the second interaction point when it is determined that the length of the line segment between the first interaction point and the second interaction point is less than the initial length; and
rotate the target object based on the first interaction point and the second interaction point when it is determined that the length of the line segment between the first interaction point and the second interaction point is equal to the initial length.

In an optional implementation of this embodiment of the present application, the apparatus 300 further includes:
an optimization module configured to, when the first interaction point and the second interaction point are located at a same position, optimize the position of the second interaction point.

It should be understood that the apparatus embodiment may correspond to the method embodiment described above. For similar descriptions, reference may be made to the method embodiment. To avoid repetitions, details are not described herein again. Specifically, the apparatus 300 shown in FIG. 13 may perform the method embodiment corresponding to FIG. 1, and the above and other operations and/or functions of the modules in the apparatus 300 are respectively intended to implement corresponding procedures of the method in FIG. 1, which are not described herein again for the sake of brevity.

The apparatus 300 in this embodiment of the present application is described above with reference to the accompanying drawings from the perspective of a functional module. It should be understood that the functional module may be implemented in the form of hardware, or may be implemented by instructions in the form of software, or may be implemented by a combination of hardware and a software module. Specifically, the steps of the method embodiment of the first aspect in the embodiments of the present application may be performed by a hardware integrated logic circuit in a processor and/or the instructions in the form of software. The steps of the method according to the first aspect disclosed in conjunction with the embodiments of the present application may be directly embodied to be performed by a hardware decoding processor or by a combination of hardware in the decoding processor and a software module. Optionally, the software module may be located in a mature storage medium in the art, such as a random access memory, a flash memory, a read-only memory, a programmable read-only memory, an electrically erasable programmable memory, or a register. The storage medium is located in a memory. The processor reads information in the memory, which is used in combination with the hardware of the processor to perform the steps in the foregoing method embodiment of the first aspect.

FIG. 14 is a schematic block diagram of an electronic device according to an embodiment of the present application. As shown in FIG. 14, the electronic device 400 may include:
a memory 410 and a processor 420. The memory 410 is configured to store a computer program, and transmit the computer program to the processor 420. In other words, the processor 420 may call the computer program from the memory 410 and run the computer program, to implement the human-computer interaction method in the embodiments of the present application.

For example, the processor 420 may be configured to perform the above embodiment of the human-computer interaction method according to instructions in the computer program.

In some embodiments of the present application, the processor 420 may include, but is not limited to,
a general-purpose processor, a digital signal processor (DSP), an application specific integrated circuit (ASIC), a field programmable gate array (FPGA) or another programmable logic device, a discrete gate or transistor logic device, a discrete hardware component, and the like.

In some embodiments of the present application, the memory 410 includes, but is not limited to:
a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of example but not restrictive description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synch link dynamic random access memory (SLDRAM), and a direct rambus random access memory (DR RAM).

In some embodiments of the present application, the computer program may be divided into one or more modules. The one or more modules are stored in the memory 410 and are executed by the processor 420, to implement the human-computer interaction method provided in the present application. The one or more modules may be a series of computer program instruction segments capable of implementing specific functions. The instruction segments are used to describe an execution process of the computer program in the electronic device.

As shown in FIG. 14, the electronic device 400 may further include:
a transceiver 430. The transceiver 430 may be connected to the processor 420 or the memory 410.

The processor 420 may control the transceiver 430 to communicate with another device, specifically to send information or data to the another device or to receive information or data sent by the another device. The transceiver 430 may include a transmitter and a receiver. The transceiver 430 may further include an antenna. There may be one or more antennas.

It should be understood that the components of the electronic device are connected to each other through a bus system. In addition to a data bus, the bus system further includes a power bus, a control bus, and a status signal bus.

The present application further includes a computer storage medium having stored thereon a computer program. The computer program, when executed by a computer, enables the computer to perform the human-computer interaction method in the above method embodiment.

An embodiment of the present application further provides a computer program product including program instructions. The program instructions, when run on an electronic device, cause the electronic device to perform the human-computer interaction method in the above method embodiment.

When implemented in software, embodiments may be entirely or partially implemented in the form of the computer program product. The computer program product includes one or more computer instructions. When the computer instructions are loaded and executed on a computer, processes or functions according to the embodiments of the present application are entirely or partially generated. The computer may be a general-purpose computer, a dedicated computer, a computer network, or another programmable apparatus. The computer instructions may be stored in a computer-readable storage medium, or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or may be a data storage device, such as an integrated server or a data center, that includes one or more usable media. The usable medium may be a magnetic medium (for example, a floppy disk, a hard disk, or a magnetic tape), an optical medium (for example, a digital video disc (DVD)), or a semiconductor medium (for example, a solid state disk (SSD)), etc.

A person of ordinary skill in the art may be aware that the modules and algorithm steps of various examples described in conjunction with the embodiments disclosed herein can be implemented in electronic hardware or a combination of computer software and electronic hardware. Whether these functions are performed in hardware or software depends on the specific application and design constraint conditions of the technical solution. A person skilled in the art can implement the described functions by using different methods for each particular application, but such implementation should not be considered as going beyond the scope of the present application.

In the several embodiments provided in the present application, it should be understood that the disclosed system, apparatus, and method may be implemented in other manners. For example, the described apparatus embodiment is merely an example. For example, the module division is merely logical function division and may be other division during actual implementation. For example, a plurality of modules or components may be combined or integrated into another system, or some features may be ignored or not performed. In addition, the displayed or discussed mutual couplings, direct couplings, or communication connections may be implemented through some interfaces. The indirect couplings or communication connections between the apparatuses or modules may be implemented in electrical, mechanical, or other forms.

The modules described as separate parts may or may not be physically separate, and parts displayed as modules may or may not be physical modules, and may be located at one position, or may be distributed on a plurality of network units. Some or all of the modules may be selected according to actual needs to achieve the objectives of the solutions of the embodiments. For example, functional modules in the embodiments of the present application may be integrated into one processing module, or each of the modules may exist alone physically, or two or more modules may be integrated into one module.

In the embodiments of the present application, the term “module” or “unit” refers to a computer program with a predetermined function or part of the computer program, which works together with other related parts to achieve a predetermined goal, and may be entirely or partially implemented by use of software, hardware (such as a processing circuit or a memory), or a combination thereof. Similarly, a processor (or a plurality of processors or a memory) may be used to implement one or more modules or units. In addition, each module or unit may be part of an overall module or unit that includes a function of the module or unit.

The foregoing descriptions are merely specific implementations of the present application, but are not intended to limit the scope of protection of the present application. Any variation or replacement readily figured out by a person skilled in the art within the technical scope disclosed in the present application shall fall within the scope of protection of the present application. Therefore, the scope of protection of the present application shall be subject to the scope of protection of the claims.

What is claimed is:

1. A human-computer interaction method, comprising:
determining a gaze point of a line of sight of a user on a target object, wherein the target object is located in a virtual space;
adjusting, in response to an interaction gesture for the gaze point, a display form of the gaze point to generate a first interaction point; and
interacting with the target object based on the first interaction point.

2. The method according to claim 1, wherein the adjusting, in response to the interaction gesture for the gaze point, the display form of the gaze point to generate the first interaction point comprises:
recognizing an obtained gesture image to obtain a gesture recognition result, wherein the gesture image is acquired by an image acquisition apparatus, and the gesture image corresponds to a left hand of the user or a right hand of the user; and
switching, in response to that the gesture recognition result is a first gesture, the display form of the gaze point from a first form to a second form based on the first gesture, and determining the gaze point in the second form to be the first interaction point.

3. The method according to claim 2, wherein the interacting with the target object based on the first interaction point comprises:
in response to determining that an interaction gesture acting on the first interaction point is the first gesture and the first gesture moves from a first position to a second position, controlling, based on a movement trajectory of the first gesture, the target object to move from the first position to the second position.

4. The method according to claim 2, wherein the interacting with the target object based on the first interaction point comprises:
in response to determining that an interaction gesture acting on the first interaction point is switched from the first gesture to a second gesture and the second gesture moves from a first position to a third position, controlling, based on a movement trajectory of the second gesture, the first interaction point to move from the first position to the third position;
interacting with the target object by at least one of:
zooming in the target object in response to that the third position is on a zoom-in control and the interaction gesture on the first interaction point is switched from the second gesture to a third gesture;
zooming out the target object in response to that the third position is on a zoom-out control and the interaction gesture on the first interaction point is switched from the second gesture to the third gesture; or
rotating the target object in response to that the third position is on a rotate control and the interaction gesture on the first interaction point is switched from the second gesture to the third gesture.

5. The method according to claim 2, wherein the interacting with the target object based on the first interaction point comprises:
in response to that interactive voice is obtained, interacting with the target object based on the interactive voice.

6. The method according to claim 5, wherein the interacting with the target object based on the interactive voice comprises:
recognizing the interactive voice to obtain a voice recognition result; and
interacting with the target object based on the voice recognition result, comprising at least one of:
moving the target object based on the voice recognition result in response to that the voice recognition result is to move the target object;
zooming in the target object based on the voice recognition result in response to that the voice recognition result is to zoom in the target object;
zooming out the target object based on the voice recognition result in response to that the voice recognition result is to zoom out the target object; or
rotating the target object based on the voice recognition result in response to that the voice recognition result is to rotate the target object.

7. The method according to claim 1, wherein the method further comprises:
redisplaying the gaze point on the target object in response to that the gaze point corresponding to the line of sight of the user moves out of an observable region of the first interaction point;
adjusting, in response to the interaction gesture for the gaze point, the display form of the gaze point to generate a second interaction point, wherein a real hand of the user corresponding to the second interaction point is different from a real hand of the user corresponding to the first interaction point; and
interacting with the target object based on the first interaction point and the second interaction point.

8. The method according to claim 7, wherein the interacting with the target object comprises: at least one of moving, zooming in, zooming out, or rotating.

9. The method according to claim 8, wherein the interacting with the target object based on the first interaction point and the second interaction point comprises:
in response to determining that an interaction gesture acting on the first interaction point and an interaction gesture acting on the second interaction point both are a first gesture, controlling, based on a movement trajectory of the first gesture, the first interaction point and the second interaction point to move;
moving the target object based on the first interaction point and the second interaction point in response to that both a movement variation amount and a movement direction of the first interaction point are the same as those of the second interaction point; and
zooming in, zooming out, or rotating the target object based on the first interaction point and the second interaction point in response to that the movement directions of the first interaction point and the second interaction point are different.

10. The method according to claim 9, wherein the zooming in, zooming out, or rotating the target object based on the first interaction point and the second interaction point in response to that the movement directions of the first interaction point and the second interaction point are different comprises:
zooming in the target object based on the first interaction point and the second interaction point in response to determining that a length of a line segment between the first interaction point and the second interaction point is greater than an initial length, wherein the initial length is a length of a line segment between the first interaction point and the second interaction point before the first interaction point and the second interaction point are controlled based on the first gesture to move;
zooming out the target object based on the first interaction point and the second interaction point in response to determining that the length of the line segment between the first interaction point and the second interaction point is less than the initial length; and
rotating the target object based on the first interaction point and the second interaction point in response to determining that the length of the line segment between the first interaction point and the second interaction point is equal to the initial length.

11. The method according to claim 7, wherein the method further comprises:
in response to that the first interaction point and the second interaction point are located at a same position, optimizing the position of the second interaction point.

12. An electronic device, comprising:
a processor and a memory, wherein the memory is configured to store a computer program, and the processor is configured to call and run the computer program stored in the memory to perform a human-computer interaction method comprising:
determining a gaze point of a line of sight of a user on a target object, wherein the target object is located in a virtual space;
adjusting, in response to an interaction gesture for the gaze point, a display form of the gaze point to generate a first interaction point; and
interacting with the target object based on the first interaction point.

13. The electronic device according to claim 12, wherein the adjusting, in response to the interaction gesture for the gaze point, the display form of the gaze point to generate the first interaction point comprises:
recognizing an obtained gesture image to obtain a gesture recognition result, wherein the gesture image is acquired by an image acquisition apparatus, and the gesture image corresponds to a left hand of the user or a right hand of the user; and
switching, in response to that the gesture recognition result is a first gesture, the display form of the gaze point from a first form to a second form based on the first gesture, and determining the gaze point in the second form to be the first interaction point.

14. The electronic device according to claim 13, wherein the interacting with the target object based on the first interaction point comprises:
in response to determining that an interaction gesture acting on the first interaction point is the first gesture and the first gesture moves from a first position to a second position, controlling, based on a movement trajectory of the first gesture, the target object to move from the first position to the second position.

15. The electronic device according to claim 13, wherein the interacting with the target object based on the first interaction point comprises:
in response to determining that an interaction gesture acting on the first interaction point is switched from the first gesture to a second gesture and the second gesture moves from a first position to a third position, controlling, based on a movement trajectory of the second gesture, the first interaction point to move from the first position to the third position;
interacting with the target object by at least one of:
zooming in the target object in response to that the third position is on a zoom-in control and the interaction gesture on the first interaction point is switched from the second gesture to a third gesture;
zooming out the target object in response to that the third position is on a zoom-out control and the interaction gesture on the first interaction point is switched from the second gesture to the third gesture; or
rotating the target object in response to that the third position is on a rotate control and the interaction gesture on the first interaction point is switched from the second gesture to the third gesture.

16. The electronic device according to claim 13, wherein the interacting with the target object based on the first interaction point comprises:
in response to that interactive voice is obtained, interacting with the target object based on the interactive voice.

17. The electronic device according to claim 16, wherein the interacting with the target object based on the interactive voice comprises:
recognizing the interactive voice to obtain a voice recognition result; and
interacting with the target object based on the voice recognition result, comprising at least one of:
moving the target object based on the voice recognition result in response to that the voice recognition result is to move the target object;
zooming in the target object based on the voice recognition result in response to that the voice recognition result is to zoom in the target object;
zooming out the target object based on the voice recognition result in response to that the voice recognition result is to zoom out the target object; or
rotating the target object based on the voice recognition result in response to that the voice recognition result is to rotate the target object.

18. The electronic device according to claim 12, wherein the method further comprises:
redisplaying the gaze point on the target object in response to that the gaze point corresponding to the line of sight of the user moves out of an observable region of the first interaction point;
adjusting, in response to the interaction gesture for the gaze point, the display form of the gaze point to generate a second interaction point, wherein a real hand of the user corresponding to the second interaction point is different from a real hand of the user corresponding to the first interaction point; and
interacting with the target object based on the first interaction point and the second interaction point.

19. The electronic device according to claim 18, wherein the interacting with the target object comprises: at least one of moving, zooming in, zooming out, or rotating.

20. A non-transitory computer-readable storage medium, configured to store a computer program, wherein the computer program causes a computer to perform a human-computer interaction method comprising:
determining a gaze point of a line of sight of a user on a target object, wherein the target object is located in a virtual space;
adjusting, in response to an interaction gesture for the gaze point, a display form of the gaze point to generate a first interaction point; and
interacting with the target object based on the first interaction point.
